(19) United States
(12) Patent Application Publication
(10) Pub. No.: US 2006/0242599 A1
(43) Pub. Date: Oct. 26, 2006

(54) Improvements in and Relating to Searching on a User Interface

(75) Inventors: Guan Chuan CHOO, Singapore (SG); Aik Tat TAN, Singapore (SG)

Correspondence Address: CREATIVE LABS, INC.;LEGAL DEPARTMENT, 1901 MCCARTHY BLVD, MILPITAS, CA, 95035, US

(73) Assignee: CREATIVE TECHNOLOGY LTD., Singapore (SG)

(21) Appl. No.: 10/907,994

(22) Filed: Apr. 22, 2005

(51) Int. Cl. G06F 3/00

(52) U.S. Cl. 715/821; 715/828

(57) ABSTRACT

There is provided a method for finding a particular item from a listing of items sorted by category, on a user interface. The user interface comprises a first portion showing the sorted listing of items and a second portion showing a listing of categories by which the items are sorted. The method comprises moving a visual marker through the listing of categories on the second portion of the user interface, those items in a given category showing on the first portion of the user interface at the same time as the visual marker passes over the given category on the second portion of the user interface; and moving the visual marker to the first portion of the user interface; and finding the particular item on the first portion of the user interface. There is also provided a user interface for finding a particular item from a listing of items sorted by category and an electronic device comprising such a user interface.

### FIELD OF THE INVENTION

The invention relates to a method for finding a particular item from a listing of items on a user interface and to a user interface for finding a particular item from a listing of items.

### BACKGROUND OF THE INVENTION

It is becoming more and more common to store items such as digital photographs or music files on an electronic device (such as a personal digital entertainment device) or a PC. As the number of items stored increases, the need arises for a means to effectively search the list for a particular item.

Some methods and user interfaces have already been proposed. However, there is a need for a method which provides quicker and easier searching for a user and which also allows the user to easily locate a particular item from the list even if he or she cannot remember in full the details of that item.

### SUMMARY OF THE INVENTION

It is an object of the invention to provide a method for finding a particular item in a listing which provides an improvement over known methods. It is a further object of the invention to provide a user interface for finding a particular item in a listing which provides an improvement over known user interfaces.

According to a first aspect of the invention, there is provided a method for finding a particular item from a listing of items sorted by category, on a user interface, the user interface comprising a first portion showing the sorted listing of items and a second portion showing a listing of categories by which the items are sorted, the method comprising the steps of:

a) moving a visual marker through the listing of categories on the second portion of the user interface, those items in a given category showing on the first portion of the user interface at the same time as the visual marker passes over the given category on the second portion of the user interface;

b) moving the visual marker to the first portion of the user interface; and

c) finding the particular item on the first portion of the user interface.

The method facilitates fast searching because searching may be performed by category searching in the second portion of the user interface rather than directly in the listing of items in the first portion. This is particularly helpful when there are a large number of items listed. As the visual marker passes over a particular category in the second portion, those items in that category appear in the first portion, which facilitates fast and easy searching and also means that the user does not necessarily need to know full details of the particular item, in order to be able to locate the particular item in the listing.

The listing of items may be sorted by category and sub-category and the method may further comprise, before step b), the steps of:

selecting a category from the listing of categories on the second portion of the user interface;

showing a listing of sub-categories within the selected category on the second portion of the user interface; and

moving the visual marker through the listing of sub-categories on the second portion of the user interface, those items in a given sub-category showing on the first portion of the user interface at the same time as the visual marker passes over the given sub-category on the second portion of the user interface.

Providing sub-categories within each category on the second portion of the user interface allows the search to be more specific and also allows faster searching, particularly when the number of items in the listing is large. This method allows a two level search via category and sub-category.

The listing of items may be sorted by category, sub-category and sub-sub-category and the method may further comprise the steps of:

selecting a sub-category from the listing of sub-categories on the second portion of the user interface;

showing a listing of sub-sub-categories within the selected sub-category on the second portion of the user interface; and

moving the visual marker through the listing of sub-sub-categories on the second portion of the user interface, those items in a given sub-sub-category showing on the first portion of the user interface at the same time as the visual marker passes over the given sub-sub-category on the second portion of the user interface.

This method allows a three level search via category, sub-category and sub-sub-category. In fact, there may be any number of levels available and this will depend, inter alia, on the size of the sorted list and the particular categories by which the items are sorted.

Step c) of finding the particular item on the first portion of the user interface may comprise moving the visual marker through the sorted listing of items on the first portion of the user interface. Step c) of finding the particular item on the first portion of the user interface may comprise selecting the particular item.

In one embodiment, the listing of categories in the second portion of the user interface comprises only those categories in which there are items in the sorted listing of items in the first portion of the user interface. That is, any categories which would be empty (i.e. not include any items from the sorted listing of items in the first portion) are not included in the category listing on the second portion. This makes searching easier because only those categories which are relevant to the listing of items are displayed. If the listing of items in the first portion of the user interface is updated with new items, the listing of categories in the second portion may also be updated.

Preferably, the user interface is displayed on an electronic device having “up” and “down” buttons. Preferably, the user interface is displayed on an electronic device having “right” and “left” buttons. Preferably, the user interface is displayed on an electronic device having a “select” button. In a preferred embodiment, the electronic device has five buttons: “up”, “down”, “right”, “left” and “select”.

In one embodiment, the listing of categories is displayed as a one-dimensional list. In that embodiment, the step of moving the visual marker through the listing of categories may comprise moving the visual marker using the “up” and “down” buttons.

In one embodiment, the listing of items is displayed as a one-dimensional list. In another embodiment, the listing of items is displayed as a two-dimensional array. If the method includes the step of moving the visual marker through the sorted listing of items on the first user interface, that step may comprise moving the visual marker using the “up” and “down” buttons. If the method includes the step of selecting the particular item on the first portion of the user interface, that step may comprise using the “select” button.

In one embodiment, step b) of moving the visual marker to the first portion of the user interface comprises moving the visual marker using the “left” button. In that case, the second portion of the user interface may be on the right hand side of the first portion. In an alternative embodiment, step b) of moving the visual marker to the first portion of the user interface comprises moving the visual marker using the “right” button. In that case, the second portion of the user interface may be on the left hand side of the first portion.

Alternatively, the second portion of the user interface may be above or below the first portion of the user interface. Preferably, the second portion of the user interface is smaller than the first portion of the user interface.

In a preferred embodiment, the user is able to move between the first and second portions of the user interface using the “left” and “right” buttons and is able to move the visual marker through the listing of categories in the second portion or the listing of items in the first portion using the “up” and “down” buttons.

Preferably, when the visual marker is on the second portion of the user interface, the second portion of the user interface is highlighted and, when the visual marker is on the first portion of the user interface, the first portion of the user interface is highlighted.

The first and second portions may be highlighted in any number of ways, for example by changing color or by becoming brighter. In one embodiment, when the visual marker is on the second portion of the user interface, the first portion of the user interface is not displayed on the user interface. In that embodiment, when the visual marker is on the first portion of the user interface, the second portion of the user interface may not be displayed on the user interface. Alternatively, the first and second portions of the user interface may change size so that the larger portion is the portion which, at that moment, includes the visual marker.

In one embodiment, after step b) of moving the visual marker to the first portion of the user interface, the category of the items shown in the first portion of the user interface is highlighted on the second portion of the user interface. In that embodiment, the user can easily see to which category the displayed item or items (in the first portion of the user interface) belongs, because that category is highlighted in the second portion, even though the visual marker has moved to the first portion.

In one embodiment, the items are sorted alphabetically and the listing of categories on the second portion comprises a listing of the letters of the alphabet. In that embodiment, the items are sorted alphabetically and the user can move through the alphabet on the second portion of the user interface to find the particular item on the first portion of the user interface. As the visual marker passes over a given letter of the alphabet in the second portion, those items beginning with the given letter are displayed on the first portion of the user interface.

In another embodiment, the items are sorted by date and the listing of categories on the second portion comprises a date listing. In that embodiment, the items are sorted by date and the user can move through the dates on the second portion of the user interface to find the particular items on the first portion of the user interface. As the visual marker passes over a given date in the second portion, those items associated with that date are displayed on the first portion of the user interface.

Alternative embodiments may be envisaged, for example where the items are sorted by file size, by time or by file type. The relevant listing is then included on the second portion.

According to a second aspect of the invention, there is provided a user interface for finding a particular item from a listing of items sorted by category, the user interface comprising:

a first portion for showing the sorted listing of items; and

a second portion for showing a listing of categories by which the items are sorted, the user interface being arranged such that, as a user moves a visual marker through the listing of categories on the second portion of the user interface, those items in a given category are displayed on the first portion of the user interface at the same time as the visual marker passes over the given category on the second portion of the user interface.

The user interface allows fast searching in the sorted listing of items by allowing a user to search via category rather than directly in the listing of items. Because the relevant portion of the sorted listing appears in the first portion as the visual marker moves over a given category in the second portion, the user can search more quickly and easily. In addition, the user does not necessarily need to be able to remember the full details of the particular item in order to find it.

The second portion of the user interface may be arranged to display a listing of sub-categories within one or more of the categories. The second portion of the user interface may be arranged to display a listing of sub-sub-categories within one or more of the sub-categories. This enables sub-categories and sub-sub-categories to be used for searching.

Preferably, the listing of categories in the second portion of the user interface comprises only those categories in which there are items in the sorted listing of items in the first portion of the user interface. Thus, any categories which are empty (i.e. do not have items in the sorted listing) are not displayed in the second portion of the user interface. This makes searching even more easy as any redundant categories are simply not displayed.

The user interface may further comprise a third portion for indicating to the user characteristics of the items in the listing of items or the categories in the listing of categories.

Preferably, the user interface is displayed on an electronic device having “up” and “down” buttons. Preferably, the user interface is displayed on an electronic device having “right” and “left” buttons. Preferably, the user interface is displayed on an electronic device having a “select” button. In a preferred embodiment, the electronic device has five buttons (or five portions of a single button): “up”, “down”, “right”, “left” and “select”.

The listing of categories on the second portion of the user interface may be a one-dimensional list. In that case, the user may be able to move the visual marker through the listing of categories using the “up” and “down” buttons on the electronic device.

The listing of items on the first portion of the user interface may be a one-dimensional list or the listing of items on the first portion of the user interface may be a two-dimensional array. The user may be able to move the visual marker through the listing of items using the “up” and “down” buttons on the electronic device.

The first and second portions of the user interface may be selected or deselected using the “left” and “right” buttons on the user interface. In one embodiment, the second portion of the user interface is smaller than the first portion of the user interface.

In one embodiment, the second portion is displayed on the right hand side of the first portion on the user interface. In another embodiment, the second portion is displayed on the left hand side of the first portion on the user interface. In another embodiment, the second portion is displayed above the first portion on the user interface. In another embodiment, the second portion is displayed below the first portion on the user interface.

The first and second portions may be changeable in size such that, when the visual marker is on the first portion, the first portion is larger than the second portion and when the visual marker is on the second portion, the second portion is larger than the first portion. The first portion may be highlighted or change color when the visual marker is on the first portion. Similarly, the second portion may be highlighted or change color when the visual marker is on the second portion.

In one embodiment, the listing of categories on the second portion of the user interface comprises a listing of the letters of the alphabet. In that embodiment, the items are sorted alphabetically and the user can move through the alphabet on the second portion of the user interface to find the particular item on the first portion of the user interface. As the visual marker passes over a given letter of the alphabet in the second portion, those items beginning with the given letter are displayed on the first portion of the user interface.

In another embodiment, the listing of categories on the second portion of the user interface comprises a date listing. In that embodiment, the items are sorted by date and the user can move through the dates on the second portion of the user interface to find the particular items on the first portion of the user interface. As the visual marker passes over a given date in the second portion, those items associated with that date are displayed on the first portion of the user interface.

According to a third aspect of the invention, there is also provided an electronic device comprising a user interface as described above.

According to the third aspect of the invention, there is also provided an electronic device for carrying out the method described above.

According to the third aspect of the invention, there is provided an electronic device comprising:

a user interface for finding a particular item from a listing of items sorted by category; and

a button for a user to navigate the user interface,

the user interface comprising: a first portion for showing the sorted listing of items; and a second portion for showing a listing of categories by which the items are sorted, the user interface being arranged such that, as a user moves a visual marker through the listing of categories on the second portion of the user interface, those items in a given category are displayed on the first portion of the user interface at the same time as the visual marker passes over the given category on the second portion of the user interface; and

the button comprising: at least one portion for moving between the first portion and the second portion on the user interface and at least one portion for moving the visual marker through the listing of categories or the listing of items.

According to the third aspect of the invention, there is provided an electronic device comprising a user interface for finding a particular item from a listing of items sorted by category; and a button for a user to navigate the user interface,

the user interface comprising a left hand portion for showing the sorted listing of items and a right hand portion for showing a listing of categories by which the items are sorted, the user interface being arranged such that, as a user moves a visual marker through the listing of categories on the right hand portion of the user interface, those items in a given category are displayed on the left hand portion of the user interface at the same time as the visual marker passes over the given category on the right hand portion of the user interface;

the button comprising a “RIGHT” portion for moving the visual marker from the left hand portion to the right hand portion, a “LEFT” portion for moving the visual marker from the right hand portion to the left hand portion and “UP” and “DOWN” portions for moving the visual marker through the listing of categories.

Features which are described in relation to one aspect of the invention may also be applicable to another aspect of the invention.

### BRIEF DESCRIPTION OF THE DRAWINGS

Exemplary embodiments of the invention will now be described with reference to the following figures, of which:

FIG. 1 is a diagram of a user interface according to a first embodiment of the invention;

FIG. 2 is a diagram showing operation of the user interface of FIG. 1;

FIG. 3 is a diagram showing a filtered alphabetical go-to bar;

FIG. 4 is a diagram showing a two-level alphabetical go-to bar;

FIG. 5 is a diagram of a user interface according to a second embodiment of the invention;

FIG. 6 is a diagram showing a filtered date go-to bar; and

FIG. 7 is a diagram showing a three-level date go-to bar.

### DETAILED DESCRIPTION OF PREFERRED EMBODIMENTS

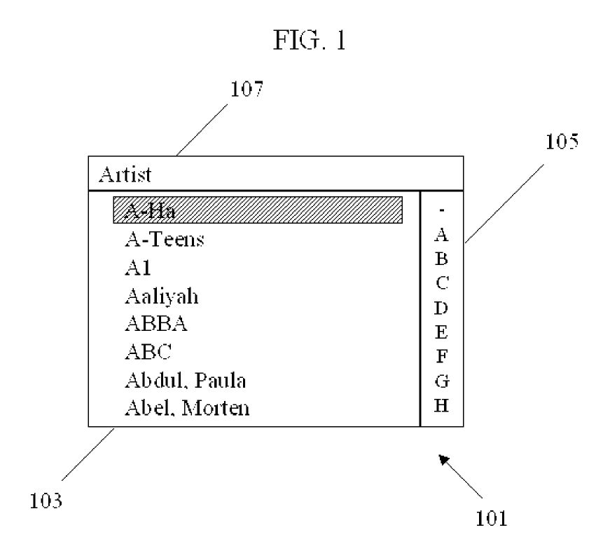

FIGS. 1 to 4 show a first embodiment of the invention. In this embodiment, the left hand portion of the user interface shows a list of music artists sorted alphabetically. This is called the content listing. The right hand portion of the user interface which, in this embodiment is termed an alphabetical go-to bar shows the alphabet and allows the user to search through the list in the left hand portion. The user interface is implemented on a device having a five-way button with “UP”, “DOWN”, “LEFT”, “RIGHT” and “OK” choices.

Referring to FIG. 1, the user interface 101 comprises a first portion in the form of a content listing 103 on the left hand side, showing an alphabetical list of music artist names. Of course, the list on the first portion could be any list that is able to be sorted alphabetically. The user interface 101 also comprises a second portion in the form of alphabetical go-to bar 105. The user interface 101 also comprises a third portion in the form of a title bar 107.

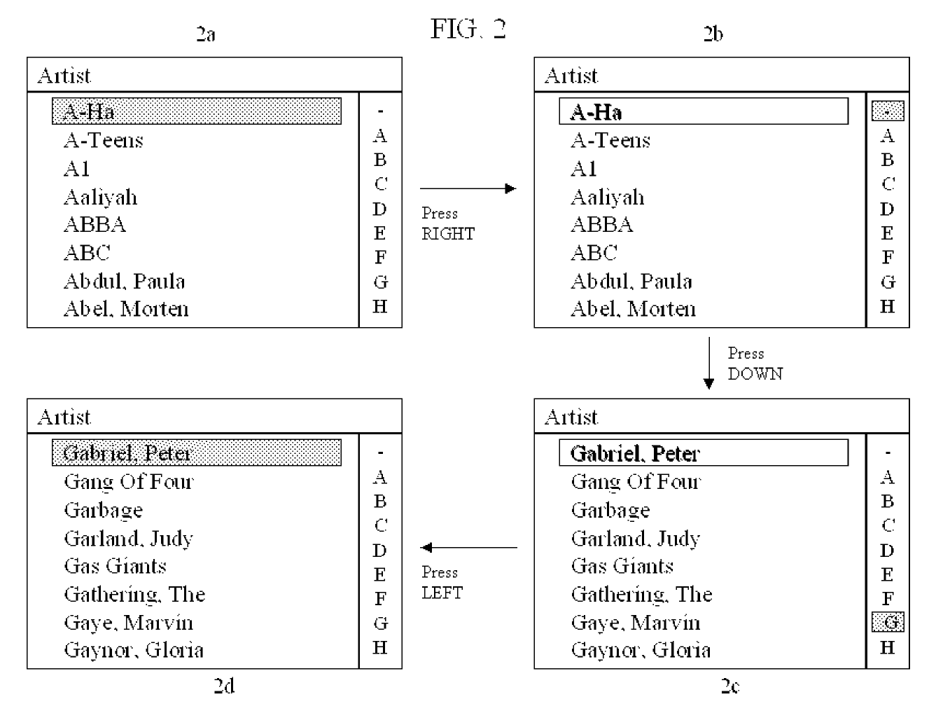

FIG. 2 shows how the five-way button on the device on which the user interface is implemented may be used to find an item from the content listing 103.

In FIG. 2a, the focus is on the content listing 103, specifically on the first item in the content listing 103. The user can move the focus to the alphabetical go-to bar 105 by pressing the “RIGHT” button. This is shown in FIG. 2b. Then, the user can scroll through the alphabetical go-to bar using the “UP” and “DOWN” buttons. As the user scrolls through, the relevant portion of the content listing 103 is shown on the left hand side. This is shown in FIG. 2c. The user does not need to select a particular letter in the alphabetical go-to bar; the relevant portion of the content listing shows up automatically. Once the user has reached the desired letter on the alphabetical go-to bar, he can use the “LEFT” button to move the focus back to the content listing 103—see FIG. 2d. If necessary, he can then scroll through the content listing 103 using the “UP” and “DOWN” buttons, to find a particular item.

As the user scrolls through the go-to bar on the right hand side, the relevant portion of the content listing immediately shows up on the left hand side. So, the content listing display jumps to the relevant section of the content listing as the user scrolls through the go-to bar. Note that, when the user returns the focus to the content listing, he can search through the content listing directly using the “UP” and “DOWN” buttons, including moving to the previous or next category. Thus, the content listing is not filtered by using the go-to bar; the display simply jumps to the appropriate portion. The user is still free to search through the entire content listing even when he has accessed a particular section of the content listing via the go-to bar.

As mentioned, as the user moves up and down the alphabet in the alphabetical go-to bar 105, the relevant portion of the content listing (i.e. those artist names beginning with the currently highlighted letter of the alphabet) shows up immediately on the content listing 103. As can be seen in FIG. 2c, the first item starting with the letter currently highlighted in the go-to bar appears at the top of the content listing, which allows as many music artist names as possible beginning with that letter to be displayed in the content listing. This makes searching easier. At FIG. 2c, if the user presses the “OK” button (when the focus is already on the alphabetical go-to bar, as shown), the next page of items (if there is one) starting with the highlighted letter is displayed in the content listing. If the user presses “OK” again, the next page of items will be displayed and so on until the first page of items starting with the highlighted letter is displayed once again. Thus, the user can scroll through the content listing within that category without needing to move the focus back to the content listing itself.

Thus, the “RIGHT” and “LEFT” buttons allow the user to select and de-select the alphabetical go-to bar, whilst the “UP” and “DOWN” buttons allow the user to scroll through either the content listing or the alphabetical go-to bar. Thus, the go-to bar can be accessed repeatedly. As the user scrolls through the alphabetical go-to bar 105, the content listing 103 is immediately updated to show those artist names (or the first few of those artist names) which begin with that letter of the alphabet.

In FIG. 2, when the focus is on the content listing (FIGS. 2a and 2d), there is no highlighter on the go-to bar. However, it may be possible in some devices which have high processing power, to keep a marker on the go-to bar even when focus is on the content listing. Thus, as the user scrolls through the content listing, the particular letter of the alphabet in the go-to bar may be highlighted in some way, such that the user can see where he is in the alphabet in the go-to bar, even when focus is on the content listing.

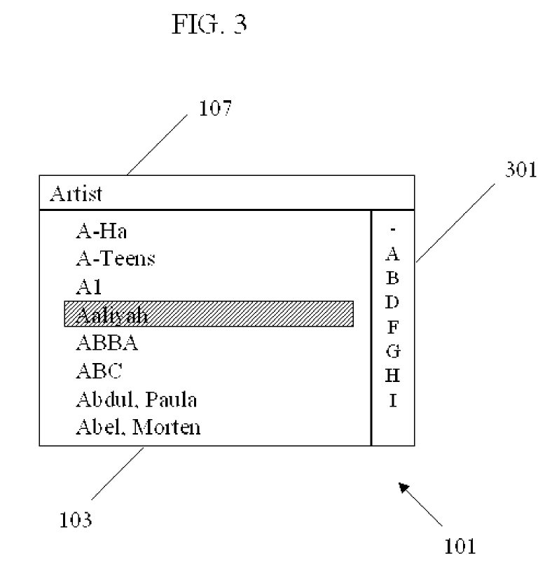

The alphabetical go-to bar may be filtered to make the search even quicker. This is shown in FIG. 3. It can be seen that, in the filtered alphabetical go-to bar 301, only those letters which have music artist names starting with that letter in the content listing are listed. In this example, there are no artist names starting with C or E in the content listing 103 so those letters are not included on the filtered alphabetical go-to bar 301.

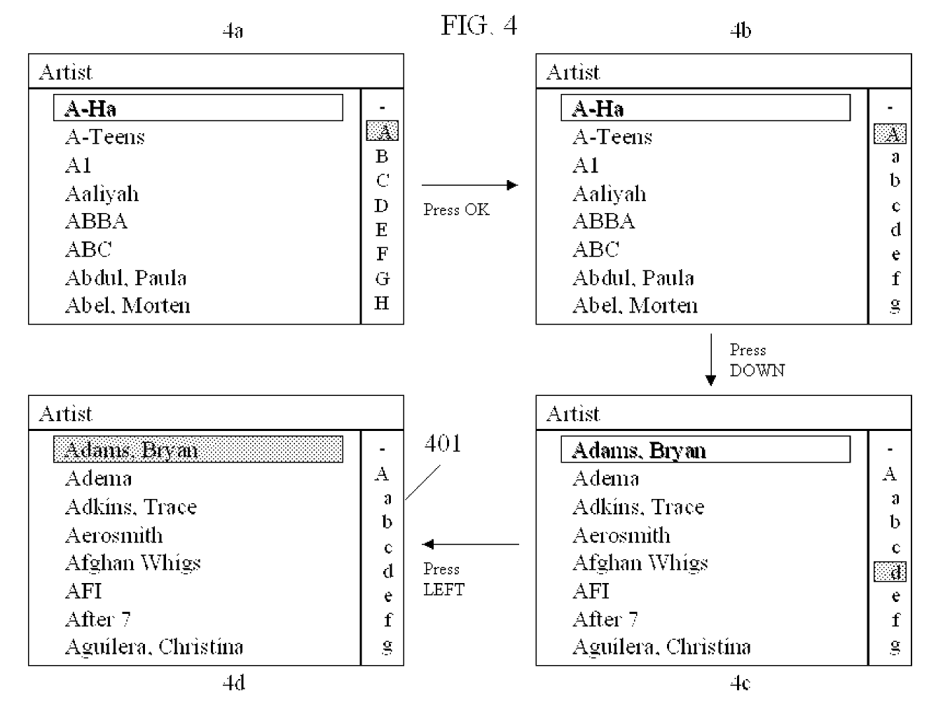

The alphabetical go-to bar may be multilevel to assist searching. This is shown in FIG. 4. Just as in FIG. 2, the alphabetical go-to bar 401 on the right hand side can be selected using the “RIGHT” button and de-selected using the “LEFT” button. The focus is initially on the content listing 103. The user can move the focus to the alphabetical go-to bar using the “RIGHT” button. This is shown in FIG. 4a. Once the user has reached the letter he wants in the alphabetical go-to bar 401, he can press the “OK” button and the next level of the alphabetical go-to bar will be displayed, which shows the second letter of the artist names. This is shown in FIG. 4b. Just as before, then the “UP” and “DOWN” buttons can be used to move through the list of second letters. This is shown in FIG. 4c. Or, pressing “OK” again will perform paging through the second letters in the alphabetical go-to bar. Once the user has reached the second letter he wants in the alphabetical go-to bar 401, he can press “LEFT” to move the focus back to the content listing—see FIG. 4d. If desired, he can then scroll through the content listing using the “UP” and “DOWN” buttons. Note that only one letter at a time is expanded in the go-to bar. For example, in FIGS. 4b, 4c and 4d, first letter A is expanded (i.e. the second letters after first letter A are shown) so all the other first letters are not expanded. The multilevel alphabetical go-to bar 401, in this case, allows two-level searching i.e. by first letter and second letter. However, further level searching is of course, possible using third letter, fourth letter and so on. The larger the number of items in the content listing, the more useful this multilevel searching will be.

The multilevel alphabetical go-to bar can, of course, be combined with a filtered go-to bar. For example, only those second letters which correspond to artist names actually present in the content listing may be displayed in the go-to bar.

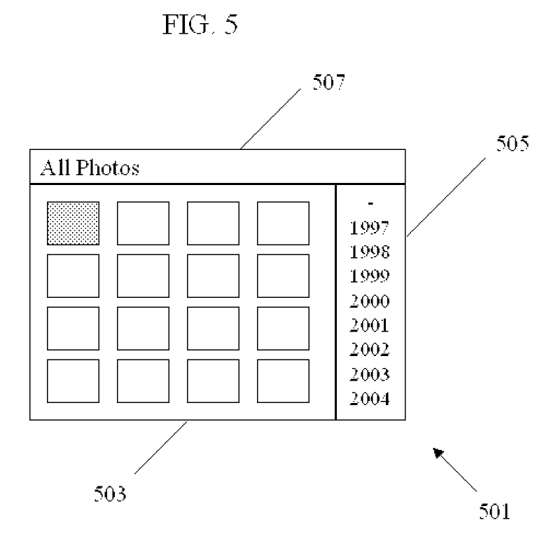

FIGS. 5 to 7 show a second embodiment of the invention. In this embodiment, the left hand portion of the user interface shows an array of photographs sorted by date when each was taken. This is called the content listing. The right hand portion of the user interface which, in this embodiment is termed a date go-to bar, shows the dates and allows the user to search through the content listing. Just as with the first embodiment, the user interface is implemented on a device having a five-way button with “UP”, “DOWN”, “LEFT”, “RIGHT” and “OK” choices.

Referring to FIG. 5, the user interface 501 comprises a first portion in the form of content listing 503 on the left hand side showing a date-ordered array of photographs. The user interface 501 also comprises a second portion in the form of date go-to bar 505 and a third portion in the form of title bar 507.

Just as in the first embodiment, the five-way button allows the user to find a particular photograph in the content listing. The “RIGHT” and “LEFT” buttons can be used to select and de-select the date go-to bar respectively, and the “UP” and “DOWN” buttons can be used to scroll through the dates in the date go-to bar or the photographs in the content listing. As the user scrolls through the date go-to bar, the relevant portion of the content listing will be shown on the left hand side. For example, as the year 1999 is reached on the date go-to bar, photographs taken in 1999 appear on the left hand side. The user does not need to press “OK” at 1999; the 1999 content listing shows up immediately.

As with the first embodiment, as the user moves through the dates in the date go-to bar, the relevant portion of the content listing shows up immediately on the content listing. Once again, the first photograph associated with the currently highlighted date is displayed at the top left of the content listing, which allows as many photographs as possible associated with that date to be displayed in the content listing. This makes searching easier. As before, if the user presses the “OK” button when the focus is already on the date go-to bar, the next page of photographs (if there is one) associated with the highlighted date is displayed in the content listing. Thus, the user can scroll through the content listing within that date without needing to move the focus back to the content listing itself.

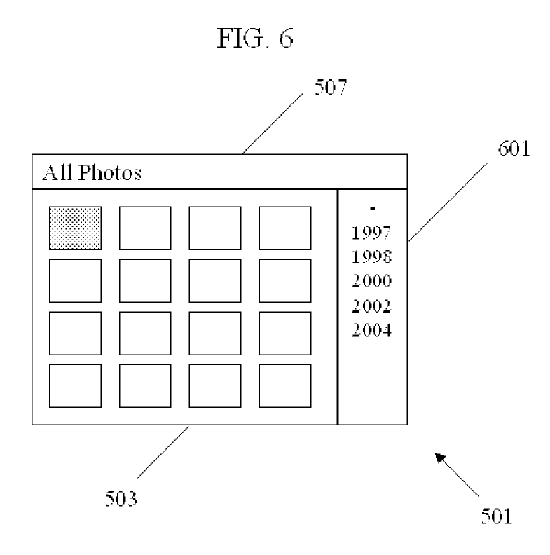

To increase the search speed, the date go-to bar may be filtered and this is shown in FIG. 6. In the filtered date go-to bar 601, only those years in which photographs in the content listing were taken are displayed. We see that no photographs in the content listing were taken in 1999, 2001 or 2003 so those years are not displayed in the filtered date go-to bar 601.

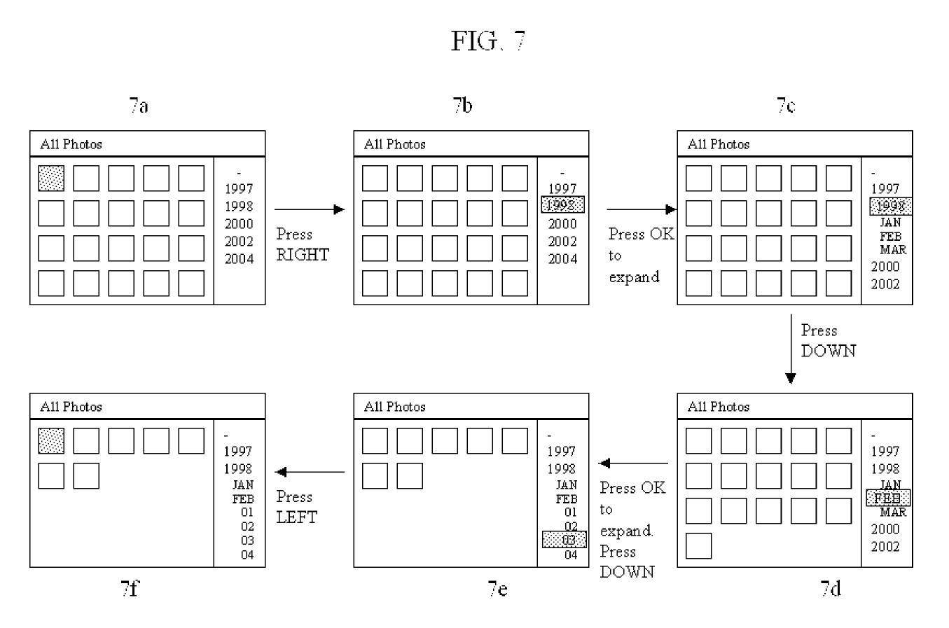

The date go-to bar may be multilevel to assist searching and this is shown in FIG. 7. In FIG. 7a, the focus is on the content listing. The user can press “RIGHT” to move the focus to the date go-to bar. This is shown in FIG. 7b. Once the user has reached the desired year (using the “UP” and “DOWN” buttons), he can press “OK” and this will show the months in that year. This is shown in FIG. 7c. Then, he can use the “DOWN” and “UP” buttons to find the desired month in that year. This is shown in FIG. 7d. Once he has reached the desired month, he can press “OK” and this will show the days in that month. This is shown in FIG. 7e. At any time, the user can de-select the go-to bar by pressing the “LEFT” button—see FIG. 7f. All the time, as the user scrolls through the years, months, days in the date go-to bar, the relevant photographs in the content listing are displayed.

FIG. 7 shows a three-level go-to bar which allows searching by year, month and day. Further level searching (for example by hour, minute) is, of course, possible.

Both first and second embodiments described above use an electronic device having “RIGHT”, “LEFT”, “UP”, “DOWN” and “OK” (or “SELECT”) buttons. This is the preferred method for the user to navigate the user interface and find the particular item of interest. However, it would of course be possible for other navigation tools to be used, for example, a mouse, pen or finger input. Such navigation methods may mean that a different layout of the user interface is preferred, for example the go-to bar may be above or below the content listing rather than to one side of the content listing. In some arrangements, it may be preferable if the go-to bar is not displayed until the content listing contains a certain number of items. For instance, if the content listing contains only four items, a go-to bar will not be particularly useful for searching so may not be displayed. However, once the content listing contains more items (the threshold could be settable by a user), the go-to bar will be displayed.

As the user uses the “RIGHT” and “LEFT” buttons to move between the content listing and the go-to bar, transition effects may occur. For example, the portion of the user interface including the focus at any particular time may be colored or highlighted in some way, or the content listing and go-to bar may change size or appearance as the user moves between them.

A go-to bar can also be used to search a content listing that contains several groups of sorted items. For example, if the content listing contains a number of folders each containing a number of files, the go-to bar could be used to search within both the folders and the files. For example, when “A” is selected in the go-to bar, the A folder names will be displayed in the content listing. When the user presses “OK” the next page of A folders will be displayed. Pressing “OK” again will display the next page of A folders or, when there are no more A folders, the first page of A files will be displayed. Pressing “OK” again will display the next page of A files until there are no more A files. At that point the display will return to the first page of A folders.

The first embodiment describes an alphabetical go-to bar and the second embodiment describes a date go-to bar, but it will be understood by the skilled person that other go-to bars are also possible. For example, the items may be sorted by file size or into categories which have been allocated by a user. For example, the user may choose to allocate categories to music files for example “Pop”, “Rock”, “Jazz”, “Classical” or choose to allocate categories to photographs for example “Summer holiday”, “Wedding”, “Dinner celebration”. A date go-to bar might be a date that a particular photograph was taken or a particular file was created or a date that a particular file was last opened or modified.

It may be possible for a given listing of items to be sorted in several different ways. For example, a listing of songs may be sorted by genre, artist name, song title or date. The user may then be able to choose which categories are listed in the go-to bar and may be able to swap between, for example an alphabetical go-to bar and a genre go-to bar, depending on the search method that is preferred.

What is claimed is:

1. A method for finding a particular item from a listing of items sorted by category, on a user interface, the user interface comprising a first portion showing the sorted listing of items and a second portion showing a listing of categories by which the items are sorted, the method comprising the steps of:
a) moving a visual marker through the listing of categories on the second portion of the user interface, those items in a given category showing on the first portion of the user interface at the same time as the visual marker passes over the given category on the second portion of the user interface;
b) moving the visual marker to the first portion of the user interface; and
c) finding the particular item on the first portion of the user interface.

2. The method of claim 1 wherein the listing of items is sorted by category an by sub-category and further comprising, before step b), the steps of:
selecting a category from the listing of categories on the second portion of the user interface;
showing a listing of sub-categories within the selected category on the second portion of the user interface; and
moving the visual marker through the listing of sub-categories on the second portion of the user interface, those items in a given sub-category showing on the first portion of the user interface at the same time as the visual marker passes over the given sub-category on the second portion of the user interface.

3. The method of claim 1, wherein step c) of finding the particular item on the first portion of the user interface comprises moving the visual marker through the sorted listing of items on the first portion of the user interface.

4. The method of claim 1, wherein step c) of finding the particular item on the first portion of the user interface further comprises selecting the particular item.

5. The method of claim 1, wherein the listing of categories in the second portion of the user interface comprises only those categories in which there are items in the sorted listing of items in the first portion of the user interface.

6. The method of claim 1, wherein the user interface is displayed on an electronic device having “up” and “down” buttons.

7. The method of claim 1, wherein the user interface is displayed on an electronic device having “right” and “left” buttons.

8. The method of claim 1, wherein, after step b) of moving the visual marker to the first portion of the user interface, the category of the items shown in the first portion of the user interface is highlighted on the second portion of the user interface.

9. The method of claim 1, wherein the items are sorted alphabetically and the listing of categories on the second portion comprises a listing of the letters of the alphabet.

10. The method of claim 1, wherein the items are sorted by date and the listing of categories on the second portion comprises a date listing.

11. A user interface for finding a particular item from a listing of items sorted by category, the user interface comprising:
a first portion for showing the sorted listing of items; and
a second portion for showing a listing of categories by which the items are sorted, the user interface being arranged such that, as a user moves a visual marker through the listing of categories on the second portion of the user interface, those items in a given category are displayed on the first portion of the user interface at the same time as the visual marker passes over the given category on the second portion of the user interface.

12. The user interface of claim 11, wherein the listing of categories in the second portion of the user interface comprises only those categories in which there are items in the sorted listing of items in the first portion of the user interface.

13. The user interface of claim 11, wherein the user interface is displayed on an electronic device having “up” and “down” buttons.

14. The user interface of claim 11, wherein the user interface is displayed on an electronic device having “right” and “left” buttons.

15. The user interface of claim 11, wherein the listing of categories on the second portion of the user interface is a one-dimensional list.

16. The user interface of claim 11, wherein the listing of items on the first portion of the user interface is a one-dimensional list.

17. The user interface of claim 11, wherein the listing of items on the first portion of the user interface is a two-dimensional array.

18. The user interface of claim 11, wherein the listing of categories on the second portion of the user interface comprises a listing of the letters of the alphabet.

19. The user interface of claim 11, wherein the listing of categories on the second portion of the user interface comprises a date listing.

20. An electronic device comprising the user interface of claim 11.

21. An electronic device for carrying out the method of claim 1.

22. An electronic device comprising:
a user interface for finding a particular item from a listing of items sorted by category; and
a button for a user to navigate the user interface,
the user interface comprising: a first portion for showing the sorted listing of items; and a second portion for showing a listing of categories by which the items are sorted, the user interface being arranged such that, as a user moves a visual marker through the listing of categories on the second portion of the user interface, those items in a given category are displayed on the first portion of the user interface at the same time as the visual marker passes over the given category on the second portion of the user interface;
the button comprising: at least one portion for moving between the first portion and the second portion on the user interface and at least one portion for moving the visual marker through the listing of categories or the listing of items.
